(19) United States
(12) Patent Application Publication
(10) Pub. No.: US 2026/0127189 A1
(43) Pub. Date: May 7, 2026

(54) SYSTEMS AND METHODS FOR INTELLIGENT CUBING OF MULTI-DIMENSIONAL DATA IN A MULTI-TENANT SYSTEM

(71) Applicant: Zuora, Inc., Redwood City, CA (US)

(72) Inventors: Siva Kumar Govindarajan, Bothell, WA (US); Rodrigo Copetti, Orlando, FL (US); Samuel Doan, Chicago, IL (US)

(21) Appl. No.: 18/938,643

(22) Filed: Nov. 6, 2024

(51) Int. Cl. G06F 16/248; G06F 16/21

(52) U.S. Cl. CPC G06F 16/248; G06F 16/211

(57) ABSTRACT

The multi-tenant system includes one or more hardware processors that obtain consumption records, the consumption records including consumption event attributes and consumption event attribute values. The one or more hardware processors recognize schemas of the obtained consumption records, generate a consumption dataset to compile the obtained consumption records based on the recognized one or more schemas, determine from the generated consumption dataset cardinalities of each of eligible consumption event attributes, generate a cubed consumption dataset from the consumption dataset based on the determined cardinalities, route the cubed consumption dataset to one or more directories of a datastore, perform analytics on the cubed consumption dataset, and output the analytics results.

### TECHNICAL FIELD

This disclosure pertains to multi-tenant subscription data, and more particularly pertains to systems and methods for intelligent cubing of multi-dimensional data, e.g., multi-tenant subscription-based resource consumption records, in a multi-tenant system.

### BACKGROUND

Some subscriptions are based on resource consumption of a subscriber. These resources may include tangible and/or intangible resources, such as data utilization, data storage, media, goods, raw materials, energy, system accesses, and/or time. Each resource consumption event may be recorded as a consumption record. Considering the huge volume of consumption records, systems and methods for paring the data are needed.

### SUMMARY

A claimed solution rooted in computer technology overcomes problems specifically arising in the realm of computer technology. In accordance with some embodiments of the present invention, an intelligent cubing system within a multi-tenant system is configured to reduce the volume of multi-dimensional data, e.g., consumption records within a consumption records database. Reducing the volume of multi-dimensional data may help to reduce resources needed to analyze the consumption records. The consumption records include data corresponding to subscription-based consumption events. In some embodiments, in a single time period, e.g., one month, the consumption records database may receive consumption records pertaining to billions of consumption events.

The intelligent cubing system obtains consumption records corresponding to consumption events, recognizes one or more schemas of the consumption records, and compiles the consumption records by generating a consumption dataset based on the recognized schema. The intelligent cubing system performs intelligent cubing on the consumption dataset, stores the cubed consumption dataset in one or more datastores, performs analytics on the cubed consumption dataset, and outputs results, e.g., in a dashboard or report.

In some embodiments, each consumption record includes consumption event attributes (subscriber name, subscriber identifier, date, time, location information, number of units, etc.) pertaining to a consumption event. The consumption event attributes include consumption event attribute values corresponding to the consumption event attributes. The consumption records may include one or more schemas for storing the consumption event attributes and corresponding values. Generating a consumption dataset from the consumption records may include compiling the data from the consumption records into a structured format, e.g., an array or a tabular format.

In some embodiments, each consumption event attribute may correspond to a dimension of the consumption dataset. The intelligent cubing system determines a cardinality of each dimension, e.g., for each consumption event attribute. The cardinality corresponds to a number of unique values of each dimension in the consumption records.

In some embodiments, the intelligent cubing system performs intelligent cubing on the consumption dataset by selectively removing dimensions, e.g., consumption event attributes, from the consumption dataset based on their respective cardinalities. In some embodiments, the intelligent cubing system removes consumption event attributes having a cardinality that exceeds an upper cardinality threshold (i.e., having too many alternative values, e.g., username, user ID, street address), and retains consumption event attributes having a cardinality within the upper cardinality threshold (i.e., having a reasonable number of alternative values, e.g., state of residence, gender). In some embodiments, the intelligent cubing system retains a given proportion or number of dimensions having lowest cardinalities or having lowest cardinalities above a minimum cardinality threshold. The intelligent cubing system selectively removes particular dimensions that are likely to have lower usefulness for analytics purposes.

After removing dimensions, certain consumption event “rows” may have identical consumption event attributes (except for possibly the unit amounts or other retained metered values). Accordingly, the intelligent cubing system may consolidate rows, while generating metrics involving the unit amounts or other metered values (e.g., sum total, average, mean, median, event count, etc.).

The reduction in the volume of data constitutes significant computer improvements, enabling more efficient utilization of processing power and more storage volume needed by the analytics processes.

Embodiments of the invention implement a multi-tenant system. The multi-tenant system includes one or more hardware processors; and memory storing computer instructions. The computer instructions, when executed by the one or more hardware processors, are configured to perform obtaining consumption records, the consumption records comprising consumption event attributes and consumption event attribute values. The computer instructions are further configured to perform recognizing one or more schemas corresponding to the obtained consumption records; generating a consumption dataset to compile the obtained consumption records based on the recognized one or more schemas; determining, from the generated consumption dataset, cardinalities of each of eligible consumption event attributes, each cardinality indicative of a number of unique consumption event attribute values of each of the eligible consumption event attributes; generating a cubed consumption dataset from the consumption dataset based on the determined cardinalities; routing the cubed consumption dataset to one or more directories of a datastore; evaluating analytics results from the cubed consumption dataset; and outputting the analytics results.

In some embodiments, the generating of the consumption dataset comprises generating the consumption dataset in a tabular format having a tabular schema consistent with the recognized one or more schemas.

In some embodiments, at least a portion of the obtained consumption records have different schemas, and the recognizing of the one or more schemas comprises combining the different schemas. For example, at least a portion of the obtained consumption records may have different consumption event attributes. The recognizing of the one or more schemas comprises recognizing all consumption event attributes across the consumption records. In some embodiments, the recognizing of the one or more schemas comprises recognizing one or more formats of the consumption records.

In some embodiments, the recognizing of the one or more schemas comprises recognizing a changed schema, the changed schema comprising an additional consumption event attribute or a removal of a previous consumption event attribute, and the generating of the consumption dataset is based on the recognized changed schema.

In some embodiments, the generating of the consumption dataset comprises populating the consumption event attributes from the consumption records; and the generating of the cubed consumption dataset from the consumption dataset comprises: selecting one or more to-be-removed consumption event attributes, from the eligible consumption event attributes, for removal from the consumption dataset; and removing the one or more to-be-removed consumption event attributes from the consumption dataset.

In some embodiments, the selecting of the one or more to-be-removed consumption event attributes comprises selecting for removal any of the eligible consumption event attributes having a cardinality that exceeds a cardinality threshold.

In some embodiments, the selecting of the one or more to-be-removed consumption event attributes comprises retaining a given number of the eligible consumption event attributes having lowest cardinalities.

In some embodiments, the selecting of the one or more to-be-removed consumption event attributes comprises retaining a given number of the eligible consumption event attributes having lowest cardinalities above a minimum cardinality threshold.

In some embodiments, the generating of the cubed consumption dataset comprises: after removing the one or more to-be-removed consumption event attributes, consolidating matching events corresponding to consumption events having common consumption event attribute values for the remaining eligible consumption event attributes into a bundle, and generating metrics associated with the bundle.

In some embodiments, the eligible consumption event attributes exclude temporal attributes indicative of a time or day of consumption and quantity attributes indicative of a quantity of consumption.

In some embodiments, the outputting comprises outputting a summary graphical representation of a multidimensional analysis, wherein the computer instructions when executed by the one or more hardware processors are further configured to perform, upon receiving a selection within the summary graphical representation, outputting a more detailed analysis relating to the selection.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 is a block diagram of a network system for providing cloud-based software-as-a-service (SAAS) services of a multi-tenant system to multiple tenants, in accordance with some embodiments of the present invention.

FIG. 2 is a block diagram illustrating details of an intelligent cubing system, in accordance with some embodiments of the present invention.

FIGS. 3A and 3B are diagrams illustrating details of a schema recognizing engine, in accordance with some embodiments of the present invention.

FIGS. 4A and 4B are diagrams illustrating details of a dataset generating engine, in accordance with some embodiments of the present invention.

FIGS. 5A, 5B, and 5C are diagrams illustrating details of an intelligent cubing engine, in accordance with some embodiments of the present invention.

FIG. 6 is a diagram illustrating details of a routing engine, in accordance with some embodiments of the present invention.

FIGS. 7A, 7B, 8 and 9 are diagrams illustrating details of an analytics engine, in accordance with some embodiments of the present invention.

FIG. 10 is a flowchart of a method of intelligently cubing consumption records, in accordance with some embodiments of the present invention.

FIG. 11 is a block diagram illustrating details of a computing system.

### DETAILED DESCRIPTION

A claimed solution rooted in computer technology overcomes problems specifically arising in the realm of computer technology. In accordance with some embodiments of the present invention, an intelligent cubing system within a multi-tenant system is configured to reduce the volume of multi-dimensional data, e.g., consumption records within a consumption records database. Reducing the volume of multi-dimensional data may help to reduce resources needed to analyze the consumption records. The consumption records include data corresponding to subscription-based consumption events. In some embodiments, in a single time period, e.g., one month, the consumption records database may receive consumption records pertaining to billions of consumption events.

The intelligent cubing system obtains consumption records corresponding to consumption events, recognizes one or more schemas of the consumption records, and compiles the consumption records by generating a consumption dataset based on the recognized schema. The intelligent cubing system performs intelligent cubing on the consumption dataset, stores the cubed consumption dataset in one or more datastores, performs analytics on the cubed consumption dataset, and outputs results, e.g., in a dashboard or report.

In some embodiments, each consumption record includes consumption event attributes (subscriber name, subscriber identifier, date, time, location information, number of units, etc.) pertaining to a consumption event. The consumption event attributes include consumption event attribute values corresponding to the consumption event attributes. The consumption records may include one or more schemas for storing the consumption event attributes and corresponding values. Generating a consumption dataset from the consumption records may include compiling the data from the consumption records into a structured format, e.g., an array or a tabular format.

In some embodiments, each consumption event attribute may correspond to a dimension of the consumption dataset. The intelligent cubing system determines a cardinality of each dimension, e.g., for each consumption event attribute. The cardinality corresponds to a number of unique values of each dimension in the consumption records.

In some embodiments, the intelligent cubing system performs intelligent cubing on the consumption dataset by selectively removing dimensions, e.g., consumption event attributes, from the consumption dataset based on their respective cardinalities. In some embodiments, the intelligent cubing system removes consumption event attributes having a cardinality that exceeds an upper cardinality threshold (i.e., having too many alternative values, e.g., username, user ID, street address), and retains consumption event attributes having a cardinality within the upper cardinality threshold (i.e., having a reasonable number of alternative values, e.g., state of residence, gender). In some embodiments, the intelligent cubing system retains a given proportion or number of dimensions having lowest cardinalities or having lowest cardinalities above a minimum cardinality threshold. The intelligent cubing system selectively removes particular dimensions that are likely to have lower usefulness for analytics purposes.

After removing dimensions, certain consumption event “rows” may have identical consumption event attributes (except for possibly the unit amounts or other retained metered values). Accordingly, the intelligent cubing system may consolidate rows, while generating metrics involving the unit amounts or other metered values (e.g., sum total, average, mean, median, event count, etc.).

The reduction in the volume of data constitutes significant computer improvements, enabling more efficient utilization of processing power and more storage volume needed by the analytics processes.

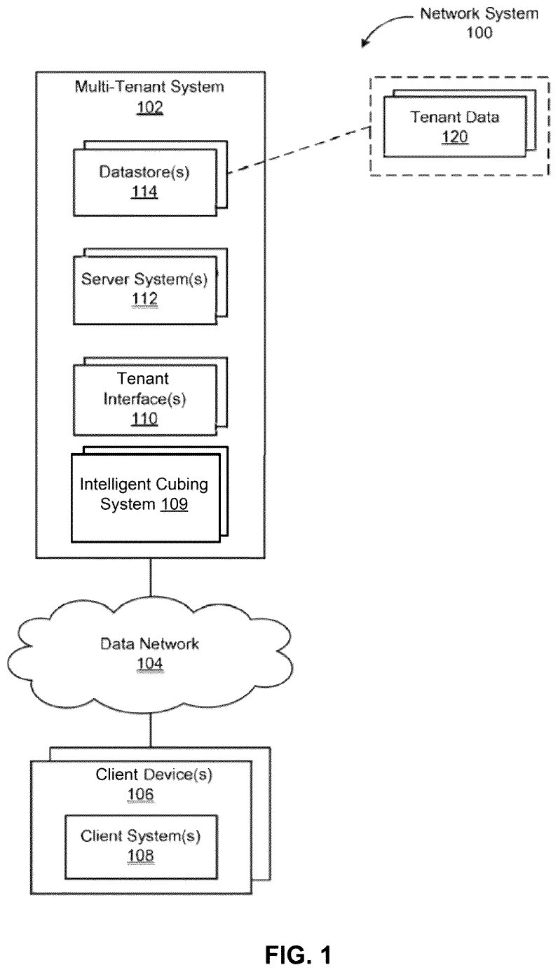

FIG. 1 is a block diagram of an example network system 100 for providing cloud-based software-as-a-service (SAAS) services of a multi-tenant system 102 to multiple tenants according to some embodiments. The teachings of FIG. 1 may be implemented in conjunction with any of the embodiments herein. Examples of cloud-based SAAS services include data storage, data processing, and business-oriented applications. In some embodiments, each tenant may be a subscription provider of resources (e.g., an internet service provider, a home security system and/or service provider, a cellular phone service provider, or entertainment content provider). Each tenant may additionally or alternatively include a group of one or more users (e.g., individuals, business entities, customers of the business entities, systems) who share access to the cloud-based services. In one embodiment, a tenant includes a service entity such as AT&T, Netflix, Verizon, and/or the like. A tenant may provide a subset of resources (e.g., products or services) of a larger entity. For example, AT&T internet products may be a particular tenant, and AT&T security products may be another tenant. In some embodiments, the cloud-based SAAS services include managing subscriber records, product and/or service consumption information, billing information, payment information, and/or the like.

The network system 100 includes the multi-tenant system 102 coupled via a data network 104 (e.g., a set of one or more public and/or private, wired and/or wireless networks) to client devices 106. The multi-tenant system 102 includes shared resources to host the cloud-based SAAS services to the tenants. The shared resources may include processors, memory, virtual systems, services, application programs, load balancers, firewalls, and/or the like. As shown, the multi-tenant system 102 includes tenant interfaces 110, server systems 112, datastores 114, and an intelligent cubing system 109. Although the description describes intelligently cubing consumption records, the invention is not to be construed to be limited to consumption records. The description may also apply to any other multi-dimensional data such as subscription records or billing records. Each of the client devices 106 includes a client system 108 that accesses the cloud-based SAAS services hosted by the multi-tenant system 102. In some embodiments, the client system 108 may be operated by employees (e.g., administrator users) of the provider of the multi-tenant system 102. In some embodiments, the client systems 108 may be operated by employees of the tenant. In some embodiments, the client systems 108 may be operated by end users (subscribers) of the tenant's services.

Each client device 106 may include a desktop, laptop, notebook, tablet, personal digital assistant, smart phone, or other consumer electronic device incorporating one or more computer components. The client system 108 on each client device 106 may include hardware, software and/or firmware for communicating with the multi-tenant system 102 and accessing the cloud-based services it hosts. Examples of the client systems 108 may include web browsers, client engines, drivers, user interface components, proprietary interfaces, and/or the like.

The multi-tenant system 102 includes hardware, software and/or firmware to host the cloud-based services for the tenants. It will be appreciated that the multi-tenant system 102 may offer access to shared resources including systems and applications on shared devices and offer each tenant the same quality or varying qualities of service. In some embodiments, the multi-tenant system 102 does not use virtualization or instantiation processes. In some embodiments, a multi-tenant system 102 integrates several business computing systems into a common system with a view toward streamlining business processes and increasing efficiencies on a business-wide level.

In some embodiments, the multi-tenant system 102 includes a user interface tier of multiple tenant interfaces 110, a server tier of multiple server systems 112, and a datastore tier of multiple datastores 114 for the multiple tenants. In some embodiments, the tenant interfaces 110 includes graphical user interfaces and/or web-based interfaces to enable tenants to access the shared services hosted by the multi-tenant system 102. The tenant interfaces 110 may support load balancing when multiple tenants (and/or multiple customers of the tenants) try to access the multi-tenant system 102 concurrently. The tenant interfaces 110 may additionally or alternatively include an operator interface for use by a systems operator to configure or otherwise manage the multi-tenant system 102. In some embodiments, tenants may input one or more customized entries corresponding to consumption event attribute fields, via the tenant interfaces 110 to be stored within datastores 114 and processed by the intelligent cubing system 109. In some embodiments, each tenant may be associated with a subset of the total tenant interfaces 110 for load balancing. In some embodiments, within the tenant interfaces 110, tenants may provide customized entries related to customized consumption event attributes (e.g., a procurement channel or delivery channel of the resources, a tenant identifier, a sector of the resources, a country in which the resources were consumed or delivered from, a method of delivery).

In some embodiments, the server systems 112 include hardware, software and/or firmware to host the shared services for tenants. The hosted services may include tenant-specific business services or functions, including enterprise resource planning (ERP), customer relationship management (CRM), eCommerce, Human Resources (HR) management, payroll, financials, accounting, calendaring, order processing, subscription billing, inventory management, supply chain management (SCM), collaboration, sales force automation (SFA), marketing automation, contact list management, call-center support, web-based customer support, partner and vendor management systems, product lifecycle management (PLM), financial, reporting and analysis, and/or the like. Similar to the tenant interfaces 110, in some embodiments, the server systems 112 may support load balancing when multiple tenants (and/or multiple customers of tenants) try to access the multi-tenant system 102 concurrently. Further, in some embodiments, each tenant may be associated with a subset of the total server systems 112 for load balancing. In some embodiments, the intelligent cubing system 109 includes hardware, software and/or firmware to consolidate subscription-based resource consumption records in real-time and in a scalable manner. For example, depending on a quantity of consumption records, the intelligent cubing system 109 may adjust a frequency of performing intelligent cubing on the consumption records. Example frequencies of consolidating the consumption records may be every thirty minutes, every hour, every few hours, every day, every week, every month or any other frequency.

In some embodiments, tenant data 120 for each tenant may be stored in a logical store across one or more datastores 114. In some embodiments, each tenant uses a logical store that is not assigned to any predetermined datastores 114. Each logical store may contain tenant data 120 that is used, generated and/or stored as part of providing tenant-specific business services or functions. In some embodiments, the datastores 114 may include relational database management systems (RDBMS), MySQL relational database systems, object-based database systems, and/or the like. In some embodiments, tenant data 120 may be stored across multiple datastores 114, with each datastore dedicated to a particular service (e.g., managing customer records, managing subscription records which may include preloaded resource parameters, managing product and/or service consumption information, managing billing information, managing payment information, and/or the like). In some embodiments, any of the datastores 114 may store information regarding any updates or event notifications. In some examples, the tenant data 120 may originally have been ingested into the datastores 114 from different sources (e.g., servers that host resources being provisioned by a tenant).

In some embodiments, the datastores 114 may include one or more virtual stores, such as cloud-based stores. The datastores 114 may store data as objects within buckets, which are containers for the objects. Each of the objects may be linked to a key which uniquely identifies an object. The objects may contain object data and metadata. The metadata may include a set of name-value pairs that describe each object.

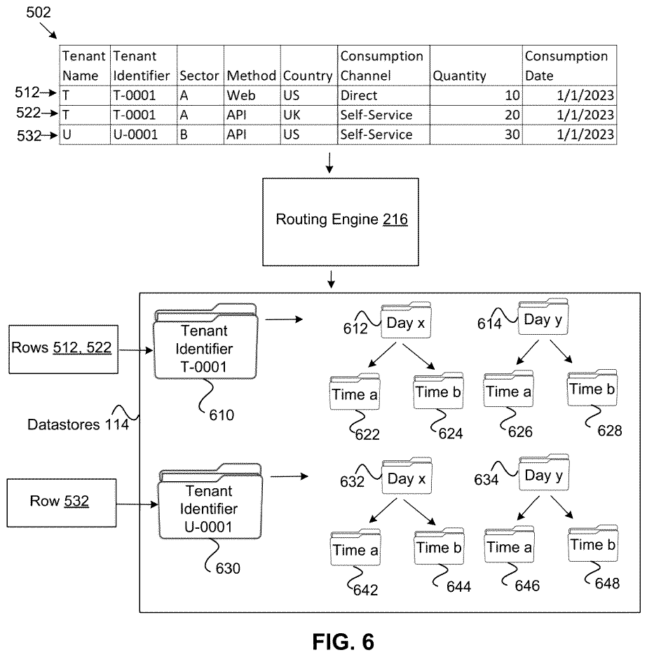

In some embodiments, the datastores 114 may store any or all of consumption records, consumption datasets generated from consumption records, cubed consumption datasets, and any portions thereof. In some embodiments, as illustrated in FIG. 6, the datastores 114 may include directories that partition data (e.g., files) for easier access and retrieval. For example, the partitions may be based on tenant and/or a time periods.

In some embodiments, although the datastores 114, the server systems 112, the tenant interfaces 110, and the intelligent cubing system 109 are shown separately, the separation is shown as merely an example of different aspects of the multi-tenant system 102. Any of the datastores 114, the server systems 112, the tenant interfaces 110, and the intelligent cubing system 109 may be integrated together and/or communicate or collaborate with one another. For example, the server systems 112 and the intelligent cubing system 109 may be integrated into a single system.

In some embodiments, the tenant data 120 may include records such as consumption records and subscription records. Subscription records include billing data, subscription status (e.g., active, canceled, suspended, re-activated), and/or geospatial data. In some embodiments, the tenant data 120 may include usage data (e.g., account activity data), such as new subscriptions, changes to subscribed products and/or services, cancellation of one or more products and/or services, subscriptions to new products and/or services, application of discounts, loyalty program package changes (e.g., additional programs and/or services, special rates, and/or the like for loyal customers), reduction or increase of rates for products and/or services, consumption records, and/or cancellation of the application. In some embodiments, account activity may include usage of a product and/or product of a subscriber (e.g., what programs or content the subscriber actually watches, what services and what level of consumption the subscriber receives, quality of the product and/or services, and/or the like).

In some embodiments, the tenant data 120 may be stored in one or more data formats (or, simply, formats). For example, subscription records may be stored in a particular format, and consumption records may be stored in another format. As used herein, formats may include data types, variable types, protocols (e.g., protocols for accessing, storing, and/or transmitting data), programming languages, scripting languages, data value parameters (e.g., date formats, string lengths), endpoint locations and/or types, schemas, and/or the like.

In some embodiments, the tenant data 120 may be stored in one or more monolithic databases and in one or more custom field databases. As stated above, the tenant data 120 may be stored in different records, e.g., a subscription record, a consumption record, a billing record, etc. Each record may be managed by a particular record object, e.g., a subscription record object, a usage record object, a billing record object, etc. Each record object may manage a number of global fields that are common to all of the tenants. For example, the global fields for a subscription record for each and every tenant may include record ID, a username, a subscription identifier, etc. The global fields may be stored in the monolithic database. Notably, different tenants may require different additional fields to store information for different record objects. For example, a first tenant may require two custom fields for a subscription record and one custom field for a consumption record. Another tenant may require three custom fields for a subscription record and four custom fields for a consumption record. Data for these custom fields can be stored in a custom field database for each record for each tenant.

The monolithic and custom field databases of the multi-tenant system 102 may manage (e.g., create, read, update, delete) tenant data 120 using different formats, different protocols, etc. A monolithic application will control data storage in the monolithic database. A custom field service (microservice) will control data storage in the custom field database. It will be appreciated that as used herein, a “service” may be single service and/or a set of services (e.g., a cluster of services).

The data network (or, communication network) 104 may represent one or more computer networks (e.g., LAN, WAN, or the like) or other transmission mediums. The data network 104 may provide communication between the systems, engines, datastores, components, and/or devices described herein. In some embodiments, the data network 104 includes one or more computing devices, routers, cables, buses, and/or other network topologies (e.g., mesh, and the like). In some embodiments, the data network 104 may be wired and/or wireless. In various embodiments, the data network 104 may include the Internet, one or more wide area networks (WANs) or local area networks (LANs), one or more networks that may be public, private, IP-based, non-IP based, and so forth.

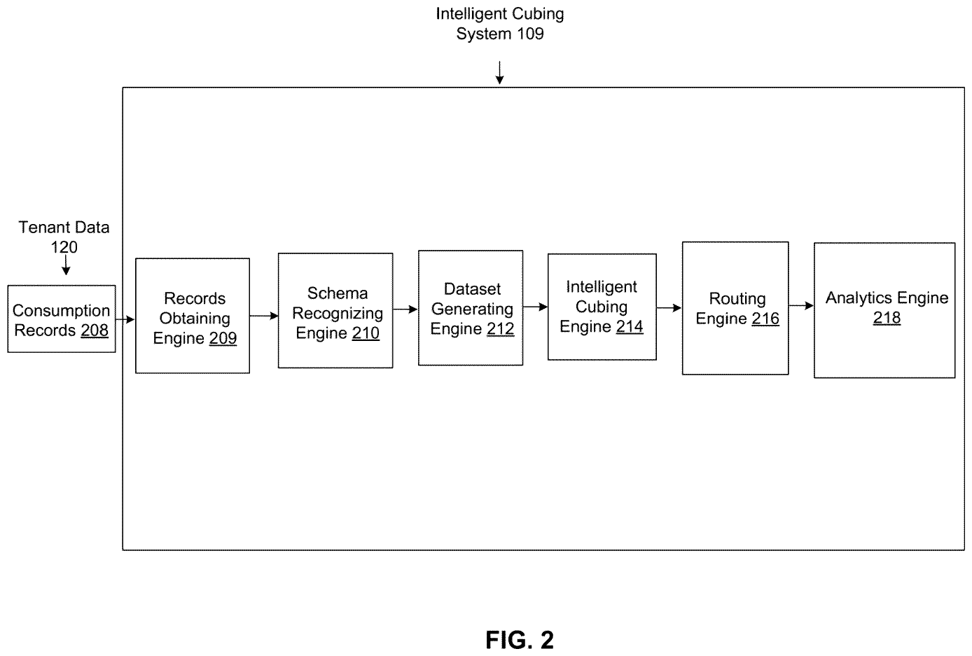

FIG. 2 is a diagram illustrating details of the intelligent cubing system 109, in accordance with some embodiments of the present invention. The intelligent cubing system 109 may include a records obtaining engine 209, a schema recognizing engine 210, a dataset generating engine 212, an intelligent cubing engine 214, a routing engine 216, and an analytics engine 218, in accordance with some embodiments of the present invention. The intelligent cubing system 109 may include one or more database systems, services, and/or microservices. Although the foregoing describes the records obtaining engine 209, the schema recognizing engine 210, the dataset generating engine 212, the intelligent cubing engine 214, the routing engine 216, and the analytics engine 218 separately for ease of understanding, the invention is not to be construed as limited to such. In some embodiments, any of the aforementioned engines may be integrated.

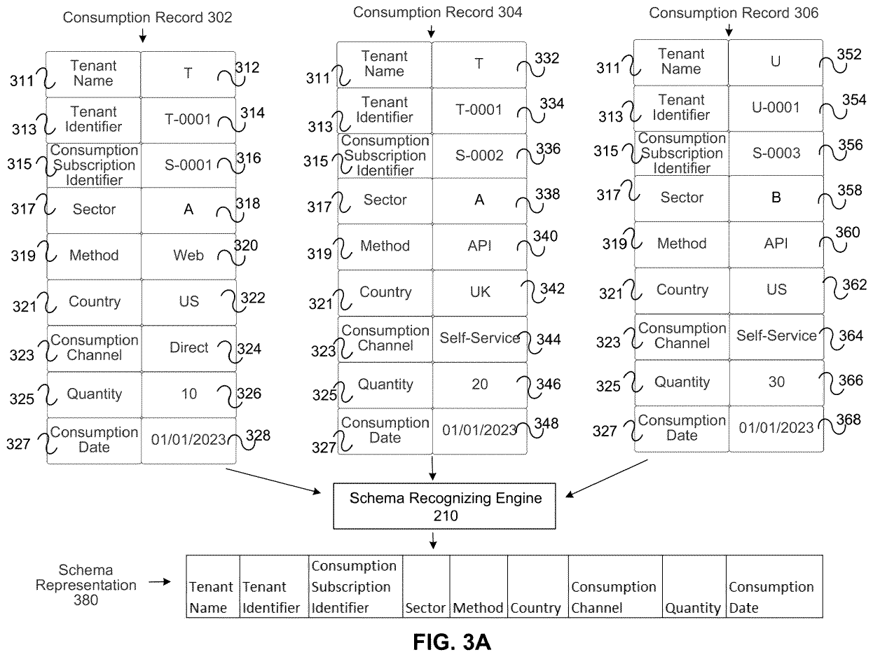

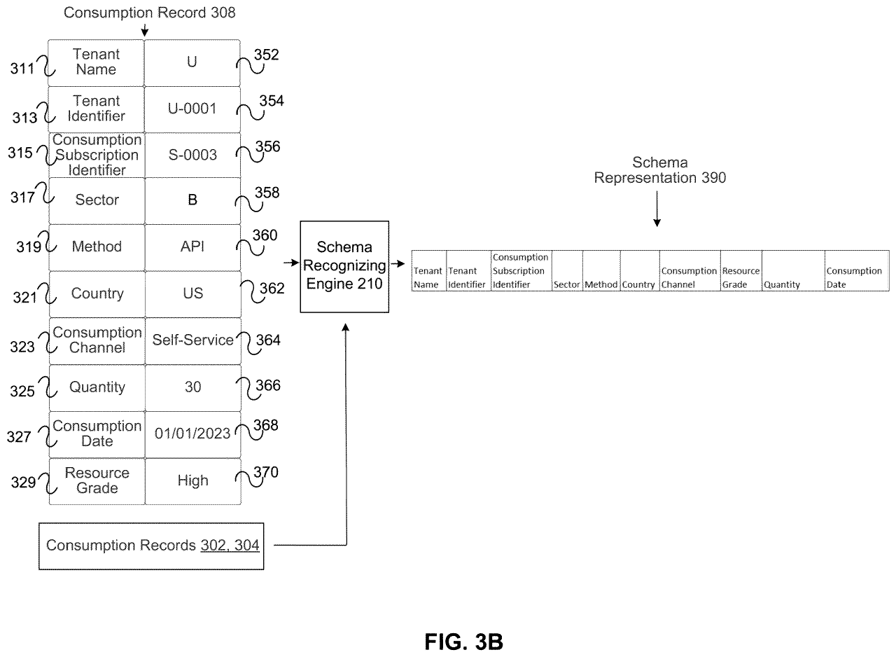

The records obtaining engine 209 includes hardware, software and/or firmware configured to obtain one or more consumption records 208 from the tenant data 120 and/or via other external systems or Application Programming Interfaces (APIs). Examples of the consumption records 208 are illustrated in FIGS. 3A and 3B.

The schema recognizing engine 210 includes hardware, software and/or firmware configured to recognize the schema of the consumption records 208. In some embodiments, the schema of the consumption records 208 includes a format, including arrangements of different consumption event attributes and values across the consumption records 208. The consumption records 208, especially from different tenants, may have different formats, consumption event attributes, and consumption event attribute values. For example, as a consumption event attribute, one tenant may include geographical data such as country of consumption, whereas another tenant may not include geographical data as a consumption event attribute. Additionally, consumption records may also be dynamic as their formats and consumption event attributes may change, even for a single tenant. The schema recognizing engine 210 is configured to recognize different and/or changing schemas. Recognizing a schema may include recognizing a format of each of the consumption records, and recognizing consumption event attributes across each of the consumption records.

In some embodiments, the schema recognizing engine 210 includes hardware, software and/or firmware configured to compare schemas of the consumption record 208 to preexisting stored schemas. The preexisting stored schemas may or may not be tenant-specific. In other embodiments, the schema recognizing engine 210 may recognize schemas of the consumption record 208 without comparison to any preexisting stored schemas.

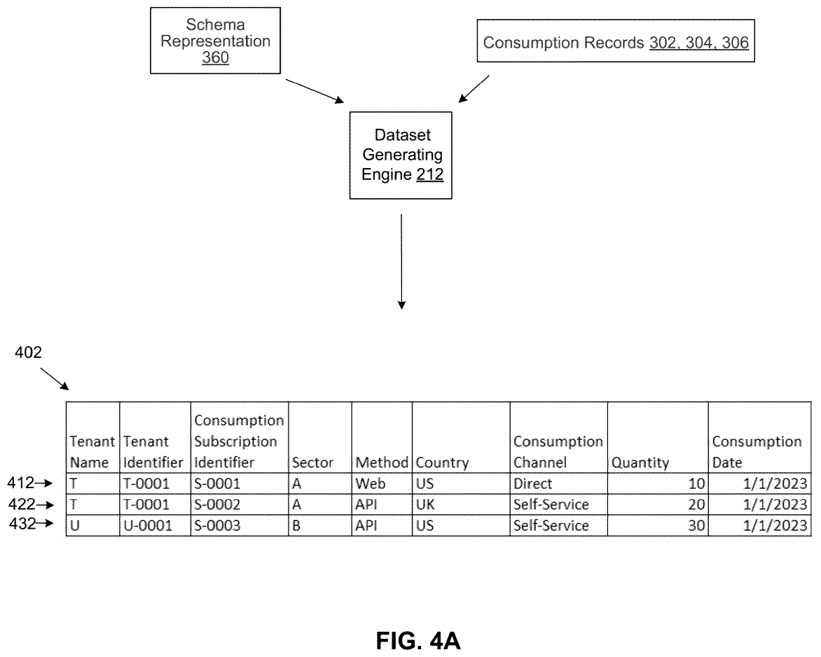

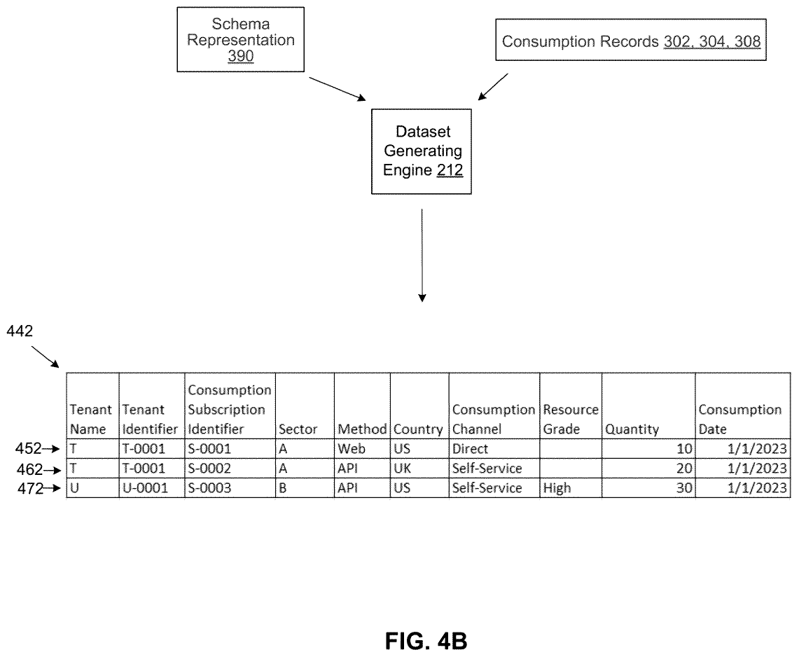

The dataset generating engine 212 includes hardware, software and/or firmware configured to generate from the consumption records 208 a consumption dataset having a structured format. In some embodiments, the dataset generating engine 212 generates a consumption dataset having a tabular format with a table schema consistent with the recognized schema. The generated consumption dataset includes the consumption event attributes. Example consumption datasets are illustrated in FIGS. 4A and 4B. In the example consumption dataset, the recognized consumption event attributes may be used as column identifiers, and consumption event attribute values of a consumption record may populate a row. Different rows provide consumption event attribute values of the different consumption records.

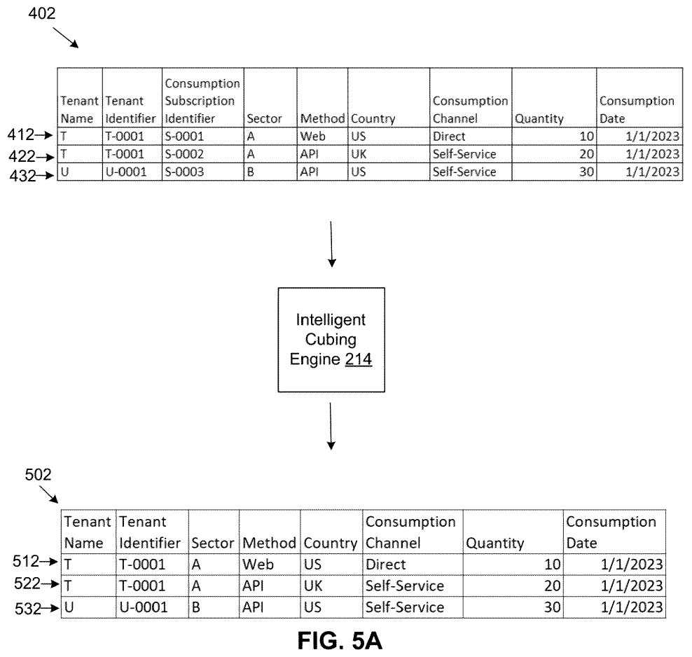

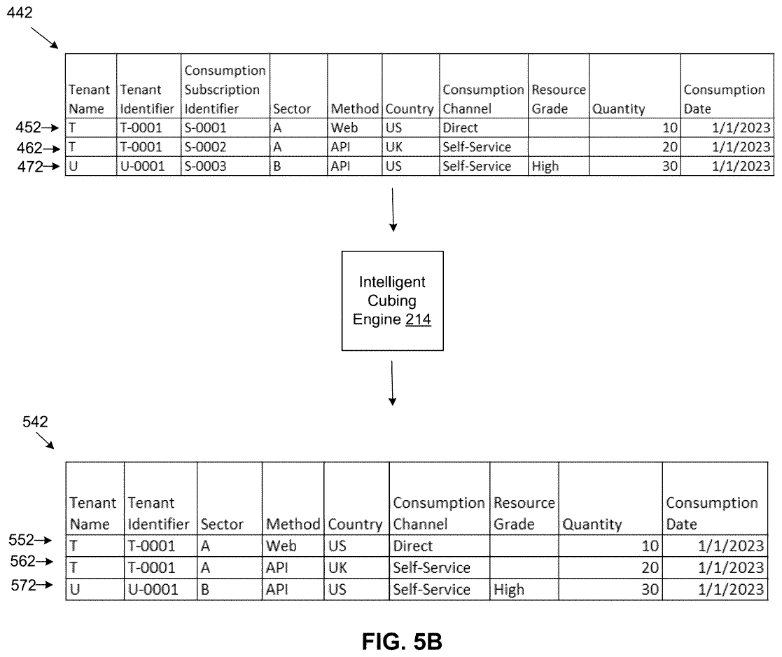

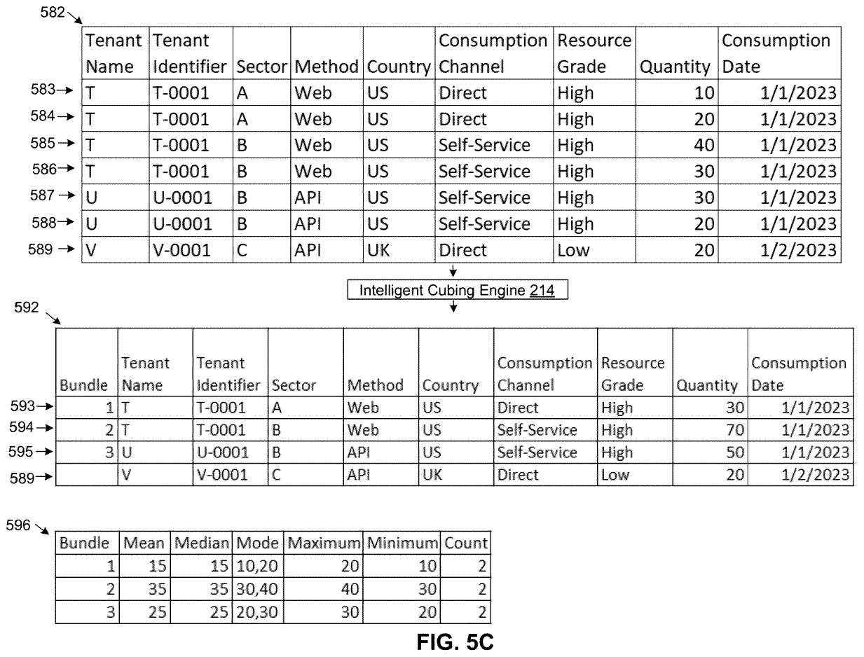

The intelligent cubing engine 214 includes hardware, software and/or firmware configured to intelligently cube the consumption dataset by selectively removing dimensions based on estimated usefulness for analytics purposes and consolidating events together based on their analytical relatedness, thereby reducing the volume of data within the consumption dataset. In some embodiments, to perform intelligent cubing, the intelligent cubing engine 214 determines a cardinality of each consumption event attribute as a separate dimension. The cardinality corresponds to the number of unique consumption event attribute values for each consumption event attribute. In some embodiments, the intelligent cubing engine 214 performs data cubing on the consumption dataset by selectively removing any dimension having a cardinality that exceeds an upper cardinality threshold, and selectively retaining any dimension for which a cardinality is within the upper cardinality threshold. Alternatively, the intelligent cubing engine 214 may retain each dimension having a cardinality between two cardinality thresholds, e.g., above a minimum cardinality threshold but below a maximum cardinality threshold. In some embodiments, the intelligent cubing engine 214 removes any dimensions for which a ratio between the cardinality and the number of the consumption records 208 exceeds a ratio threshold. In some embodiments, the intelligent cubing engine 214 retains (or removes) a given number of dimensions. For example, the intelligent cubing engine 214 may retain a given number of dimensions, e.g., ten having lowest cardinalities or lowest cardinalities greater than a minimum cardinality threshold, e.g., greater than one. Notably, consumption event attributes that have a high cardinality are removed because they are likely to be of little to no value and/or because they would demand too many resources in the analytics process. An example cubed consumption dataset is illustrated in FIG. 5.

After removing dimensions, the intelligent cubing engine 214 may consolidate certain consumption event “rows” that have identical remaining consumption event attributes (except for possibly the unit amounts or other retained metered values). Accordingly, the intelligent cubing engine 214 may consolidate rows, while generating metrics involving the unit amounts or other metered values (e.g., sum total, average, mean, median, event count, etc.).

The intelligent cubing engine 214 may further modify the cubed consumption dataset to facilitate storage. For example, the intelligent cubing engine 214 may compress and/or encode cubed consumption data. The intelligent cubing engine 214 may convert the cubed consumption dataset into a binary format or other format to further reduce its storage footprint. The intelligent cubing engine 214 may embed metadata into the cubed consumption dataset such as the schema, the number of dimensions (e.g., the number of consumption event attributes), the cardinality information, and/or encoding type. In some embodiments, the intelligent cubing engine 214 may convert the cubed consumption dataset into a Parquet file format or a different file format. Portions of the converted cubed consumption dataset may be readily separable to facilitate flexible storage.

The routing engine 216 includes hardware, software and/or firmware configured to store the cubed consumption dataset in one or more datastores, e.g., in one or more datastores 114, in accordance with some embodiments of the present invention. As further illustrated in FIG. 6, the routing engine 216 routes different entries or rows of the cubed consumption dataset to different directories within the one or more datastores 114.

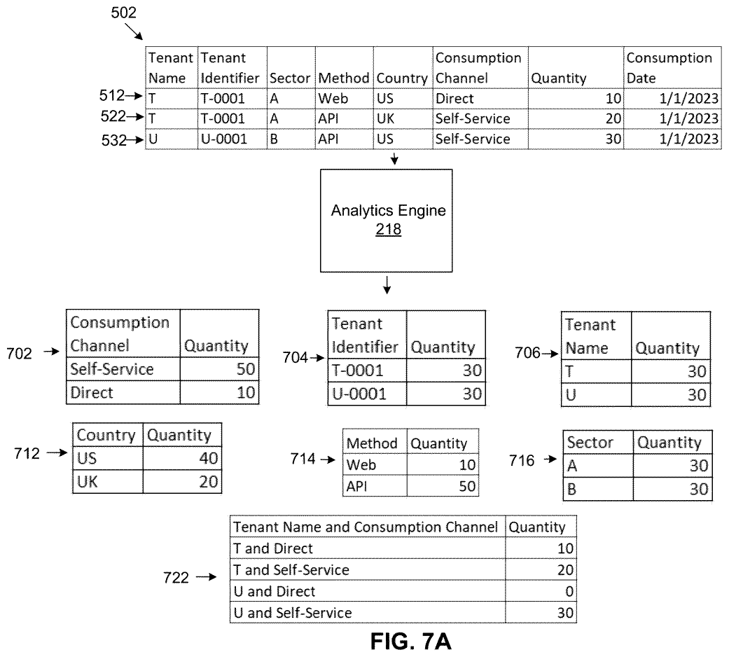

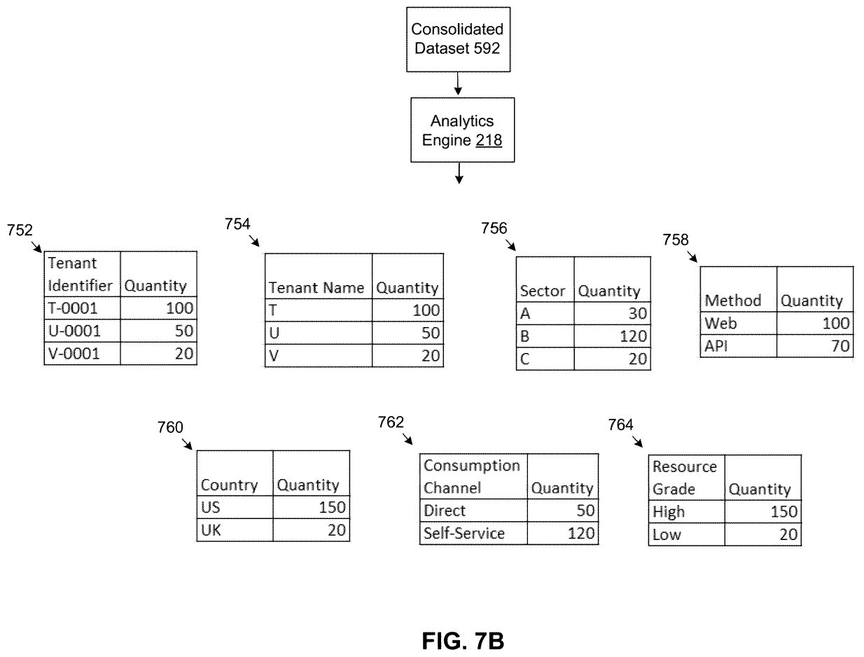

The analytics engine 218 includes hardware, software and/or firmware configured to retrieve relevant portions of the cubed consumption dataset and perform analytics. In some embodiments, the analytics engine 218 may perform the analytics in response to a query. In other embodiments, the analytics engine 218 may present its results in a dashboard. Examples of outputs of the analysis are illustrated in FIGS. 7-9.

FIGS. 3A and 3B are diagrams each illustrating example records 302, 304, 306 upon which the schema recognizing engine 210 operates to generate a schema representation 380. In FIG. 3A, example consumption records 302, 304, 306 may be implemented as the consumption records 208 of FIG. 2. The consumption records 302, 304, 306 may include consumption event attributes 311, 313, 315, 316, 319, 321, 323, 325, and 327 corresponding to tenant name, tenant identifier, consumption subscription identifier, industry sector, a method by which subscription resources were requested, a country in which the subscription resources were consumed, a consumption channel, a quantity of subscription resources consumed, and a consumption date. Fewer, more or different consumption event attributes are also contemplated. Although the consumption records 302, 304, 306 illustrate the same consumption event attributes, different consumption records may also have different consumption event attributes. In the consumption event record 302, each of the consumption event attributes 311, 313, 315, 316, 319, 321, 323, 325, and 327 corresponds to a respective consumption event attribute value 312, 314, 316, 318, 320, 322, 324, 326, and 328. In the consumption record 304, each of the consumption event attributes 311, 313, 315, 316, 319, 321, 323, 325, and 327 corresponds to a respective consumption event attribute value 332, 334, 336, 338, 340, 342, 344, 346, and 348. In the consumption record 306, each of the consumption event attributes 311, 313, 315, 316, 319, 321, 323, 325, and 327 corresponds to a respective consumption event attribute value 352, 354, 356, 358, 360, 362, 364, 366, and 368.

The schema recognizing engine 210 recognizes a schema of each of the consumption records 302, 304, and 306. By recognizing the schema, the schema recognizing engine 210 obtains the consumption event attributes of the consumption records 302, 304, and 306. The schema recognizing engine 210 searches through the consumption records 302, 304, and 306 to extract the different consumption event attributes 311, 313, 315, 316, 319, 321, 323, 325, and 327 across the consumption records 302, 304, and 306. The schema recognizing engine 210 may recognize a schema representation 380 that includes the consumption event attributes across the consumption records 302, 304, and 306. The schema recognizing engine 210 may recognize the schemas of the consumption records 302, 304, and 306 by comparison to preexisting schemas, or without comparison to any preexisting schemas.

As indicated above, the consumption event attributes may be different for at least some of the consumption records, as illustrated in FIG. 3B. For example, a consumption record 308 has an additional consumption event attribute 329 corresponding to resource grade or quality. The schema recognizing engine 210 recognizes the additional consumption event attribute 329. The additional consumption event attribute 329 includes an additional entry within a schema representation 390, even if the other consumption records 302 and 304 did not have the additional consumption event attribute 329. The schema recognizing engine 210 thus recognizes a schema that includes any consumption event attributes across all consumption records 302, 304, and 306, even if the consumption records have different schemas (different consumption event attributes and consumption event values).

FIG. 4A is a diagram illustrating an example implementation of the dataset generating engine 212. In FIG. 4A, the dataset generating engine 212 obtains the schema representation 380 and the consumption records 302, 304, and 306 (FIG. 3A). The dataset generating engine 212 generates a consumption dataset 402 that compiles the consumption records 302, 304, and 306 into a structured format. In some embodiments, the dataset generating engine 212 generates the consumption dataset 402 having a tabular format with a table schema that is consistent with the schema representation 380. In FIG. 4A, the dataset generating engine 212 populates column identifiers of the consumption dataset 402. The column identifiers correspond to the consumption event attributes within the schema representation 380. The dataset generating engine 212 populates consumption event attribute values corresponding to each consumption record in a different row. A row 412 includes consumption event attribute values of the consumption record 302. A row 422 includes consumption event attribute values of the consumption record 304. A row 432 includes consumption event attribute values of the consumption record 306. In some embodiments, other consumption datasets of different formats may also be implemented. For example, the consumption event attributes may be arranged across a column instead of a row. Generating the consumption dataset 402 facilitates the consolidation of the consumption dataset 402 in a subsequent process, as illustrated in FIG. 5A.

As illustrated in FIG. 4B, in some embodiments, some of the consumption event attribute values may be blank or null. As shown in FIG. 4B, the dataset generating engine 212 obtains the schema representation 390 and the consumption records 302, 304, and 308 (FIG. 3B). The dataset generating engine 212 generates a consumption dataset 442 that compiles the consumption records 302, 304, and 308 into a structured format, in a similar manner as described in FIG. 4A. The consumption dataset 442 includes rows 452, 462, and 472, which include consumption event attribute values of the consumption records 302, 304, and 308, respectively. The consumption dataset 442 includes blank or null entries in the rows 452 and 462 corresponding to the resource grade consumption event attribute.

FIG. 5A is a diagram illustrating an example implementation of the intelligent cubing engine 214. As shown in FIG. 5A, the intelligent cubing engine 214 obtains the consumption dataset 402 corresponding to FIG. 4A. In some embodiments, the intelligent cubing engine 214 selectively removes one or more dimensions (e.g., consumption event attributes) of the consumption dataset 402 that have relatively high cardinalities (e.g., low usefulness for certain analytics purposes). The removed consumption event attributes are thus excluded from future analytics, thereby conserving processing power with little to no sacrifice of informational value. In some embodiments, certain metered consumption event attributes are not removed. These metered consumption event attributes include temporal attributes (e.g., date or time of consumption or delivery) and quantities consumed. These metered consumption event attributes are needed for the analytics process. Therefore, only a subset of the consumption event attributes are eligible dimensions for removal.

The intelligent cubing engine 214 evaluates a cardinality of each of the eligible consumption event attributes. The cardinality represents a number of unique consumption event attribute values of each of the eligible consumption event attributes. In the consumption dataset 402, a cardinality of the tenant name attribute is two because there are two different consumption event attribute values, namely, T and U, across the rows 412, 422, and 432. A cardinality of the tenant identifier attribute is two because there are two different consumption event attribute values, namely, T-0001 and U-0001, across the rows 412, 422, and 432. A cardinality of the consumption subscription identifier attribute is three because there are three different consumption event attribute values, namely, S-0001, S-0002, and S-0003, across the rows 412, 422, and 432. The intelligent cubing engine 214 evaluates the cardinalities of the other eligible consumption event attributes, such as the sector attribute, the method attribute, the country attribute, and the consumption channel attribute, to be two. Actual consumption datasets will have many more consumption event attributes, some with unmanageably higher cardinalities. The same principles of evaluating cardinalities are applicable to larger consumption datasets.

In some embodiments, the intelligent cubing engine 214 may remove any eligible consumption event attributes for which the cardinalities exceed an upper cardinality threshold. In this minimalist example, assume that the upper cardinality threshold is two. Thus, any eligible consumption event attributes having cardinalities greater than two may be removed while any eligible consumption event attributes having cardinalities less than or equal to two may be retained. In this scenario, the consumption event attribute of consumption subscriber would be removed because its cardinality is three, while the other consumption event attributes would be retained. The intelligent cubing engine 214 removes the column corresponding to the consumption subscriber attribute, resulting in a cubed consumption dataset 502 having rows 512, 522, and 532. Here, the intelligent cubing engine 214 only removes a single consumption event attribute from the consumption dataset 402. In more realistic scenarios having billions of records, a greater proportion and number of consumption event attributes will be removed from the consumption dataset 402.

In other embodiments, the intelligent cubing engine 214 may retain only consumption event attributes having a cardinality greater than a minimum cardinality threshold but lower than an upper cardinality threshold. For example, in some embodiments, a cardinality of one may pose little to no benefit. That is, a tenant which has only US subscribers and only sells wheat likely does not need reports indicating that it has only US subscribers and only sells wheat.

In other embodiments, instead of removing consumption event attributes based on threshold cardinality values, the intelligent cubing engine 214 may retain a given number of consumption event attributes that have lowest cardinalities while removing any other consumption event attributes or a given number of consumption event attributes having cardinalities above a minimum cardinality threshold.

FIG. 5B is a diagram illustrating an example implementation of the intelligent cubing engine 214. As shown in FIG. 5B, the intelligent cubing engine 214 obtains the consumption dataset 442 corresponding to FIG. 4B. The intelligent cubing engine 214 generates a cubed consumption dataset 542 with rows 552, 562, and 572. As shown in FIG. 5B, the consumption event attribute of consumption subscription identifier has been removed, using principles as described in FIG. 5A.

In some embodiments, following the selective removal of eligible consumption event attributes, the intelligent cubing engine 214 evaluates the remaining eligible consumption event attributes to selectively consolidate events (e.g., rows) within the cubed consumption dataset, as illustrated in FIG. 5C. The consolidation may include merging any matching rows into a single row. Matching rows may refer to a group of rows have matching consumption event attribute values corresponding to the remaining eligible consumption event attributes. Thus, matching rows may constitute a common category of subscriber and/or tenant characteristics. In the minimalist examples of FIGS. 5A and 5B, none of the rows within the cubed consumption datasets 502 or 542 constitute matching rows. In FIG. 5C, the intelligent cubing engine 214 obtains and evaluates a cubed consumption dataset 582. The cubed consumption dataset has rows 583-589 corresponding to different consumption events. A pair of rows 583 and 584 constitute matching rows because they have matching consumption event attribute values, and may be merged together as a first bundle. A pair of rows 585 and 586 constitute matching rows because they have matching consumption event attribute values, and may be merged together as a second bundle. A pair of rows 587 and 588 constitute matching rows because they have matching consumption event attribute values, and may be merged together as a third bundle. As illustrated in FIG. 5C, the intelligent cubing engine 214 generates a consolidated consumption dataset 592, which includes the first bundle corresponding to row 593, the second bundle corresponding to row 594, and the third bundle corresponding to row 595. In row 593, the intelligent cubing engine 214 aggregates the quantities across the rows 583 and 584. In row 594, the intelligent cubing engine 214 aggregates the quantities across the rows 585 and 586. In row 595, the intelligent cubing engine 214 aggregates the quantities across the rows 587 and 588.

In some embodiments, the intelligent cubing engine 214 may generate metrics 596 corresponding to each bundle, e.g., to the first bundle, the second bundle, and the third bundle. These metrics may include, as nonlimiting examples, mean, median, mode, maximum, minimum, count, or standard deviation of the quantities consumed across the consumption events merged within a given bundle. In some embodiments, the intelligent cubing engine 214 may embed the metrics, similar to metadata, within the consolidated consumption dataset 592.

The consolidation process shown in FIG. 5C reduces the number of rows (in addition to reducing the number of columns as described in FIGS. 5A and 5B). By reducing the dataset and generating metrics, the analytics results can be more generated with reduced resource demand.

FIG. 6 is a diagram illustrating an example implementation of the routing engine 216. As shown in FIG. 6, the routing engine 216 obtains the cubed consumption dataset 502, according to FIG. 5A, and routes the cubed consumption dataset 502 to one or more datastores (e.g., one or more of the datastores 114). Additionally or alternatively, the routing engine 216 may obtain and route the cubed consumption dataset 592 (or in some embodiments without event consolidation the cubed consumption dataset 542) to the one or more datastores.

The datastores 114 may include directories, which partition the datastores 114 for easy retrieval of relevant consumption data. In some embodiments, the directories may correspond to consumption data of different tenants and/or different time periods of one or more tenants. The directories include tenant level directories 610 and 630, each of which stores cubed consumption data identifying a different tenant, and temporal level directories 612, 614, 622, 624, 626, 628, 632, 634, 642, 644, 646, and 648, each of which stores consumption data identifying a different day or time period. In some embodiments, the temporal level directories 612, 614, 622, 624, 626, 628, 632, 634, 642, 644, 646, and 648 may be sub-directories that are hierarchically organized under one of the tenant level directories 610 and 630. In the example illustrated in FIG. 6, the tenant level directory 610 stores consumption data corresponding to the tenant identifier attribute field T-0001 while the tenant level directory 630 stores consumption data corresponding to the tenant identifier attribute field U-0001. Thus, the routing engine 216 routes the rows 512 and 522, which contain the tenant identifier T-0001, to the tenant level directory 610. The routing engine 216 routes the rows 532 to the tenant level directory 630.

In some embodiments, the temporal level directories 612, 614, 622, 624, 626, and 628 may store cubed consumption data for consumption records of different time periods corresponding to the tenant identifier attribute field T-0001. For example, the temporal level directories 612 and 614 may store cubed consumption data of Jan. 1, 2023 and Jan. 2, 2023, respectfully. For Jan. 1, 2023, the temporal level directory 622 may store cubed consumption data of consumption records of between 1:00 AM and 2:00 AM while the temporal level directories 624 may store cubed consumption data of consumption records between 2:00 AM and 3:00 AM. For Jan. 2, 2023, the temporal level directory 626 may store cubed consumption data of consumption records between 1:00 AM and 2:00 AM while the temporal level directories 628 may store cubed consumption data of consumption records between 2:00 AM and 3:00 AM. Similarly, the temporal level directories 632, 634, 642, 644, 646, and 648 may store cubed consumption data for consumption records of different days and/or different times corresponding to the tenant identifier attribute field U-0001. Other embodiments are also possible.

Partitioning based on tenant identifier and time period facilitates efficient retrieval of relevant data in response to a query. Frequently, queries may be specific to tenant identifiers and/or time periods. To obtain the relevant consumption data for a particular tenant, only a particular tenant level directory corresponding to that tenant identifier being queried needs to be accessed, instead of accessing the entire datastore 114.

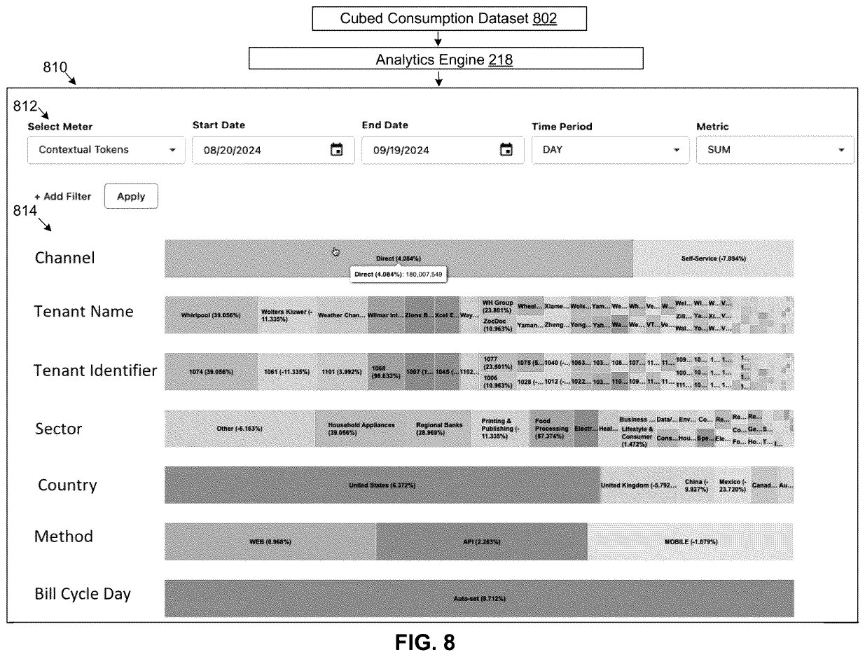

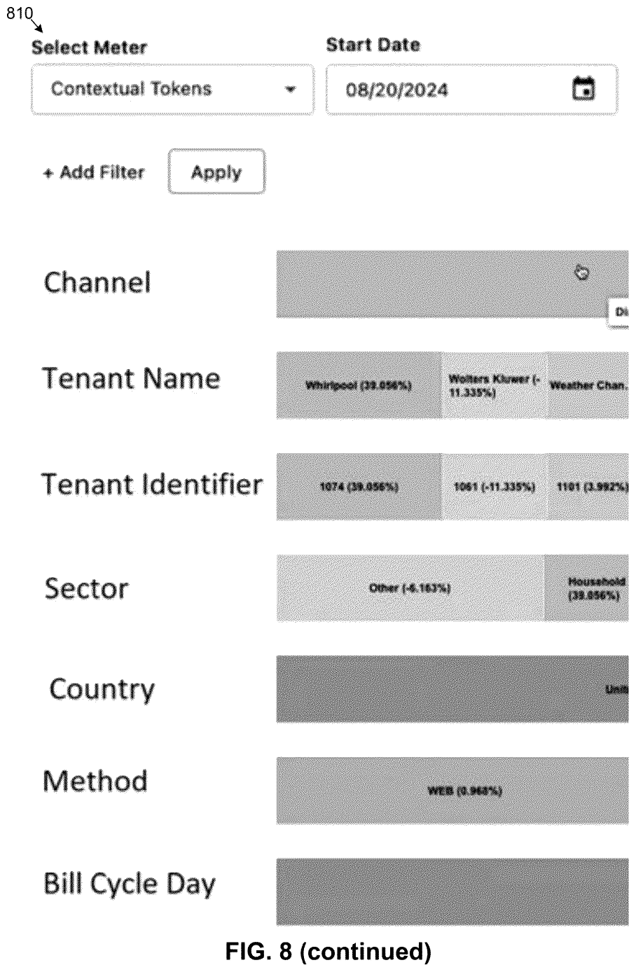

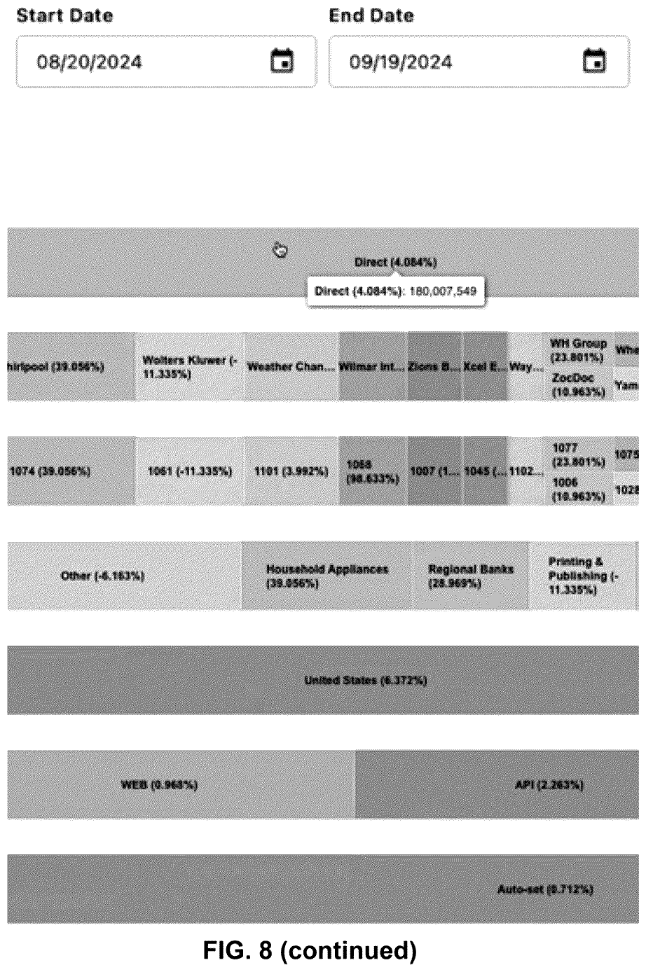

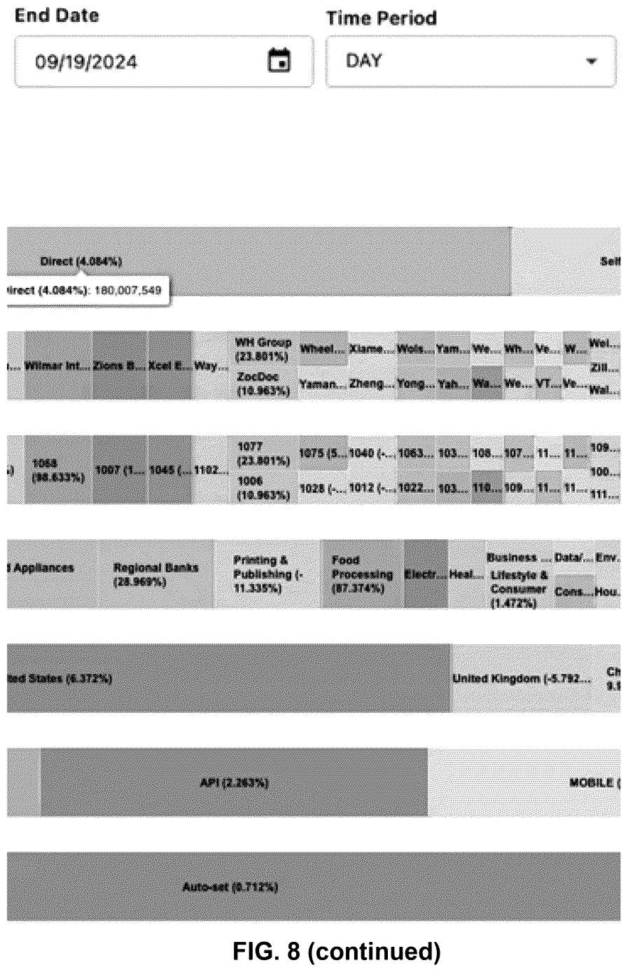

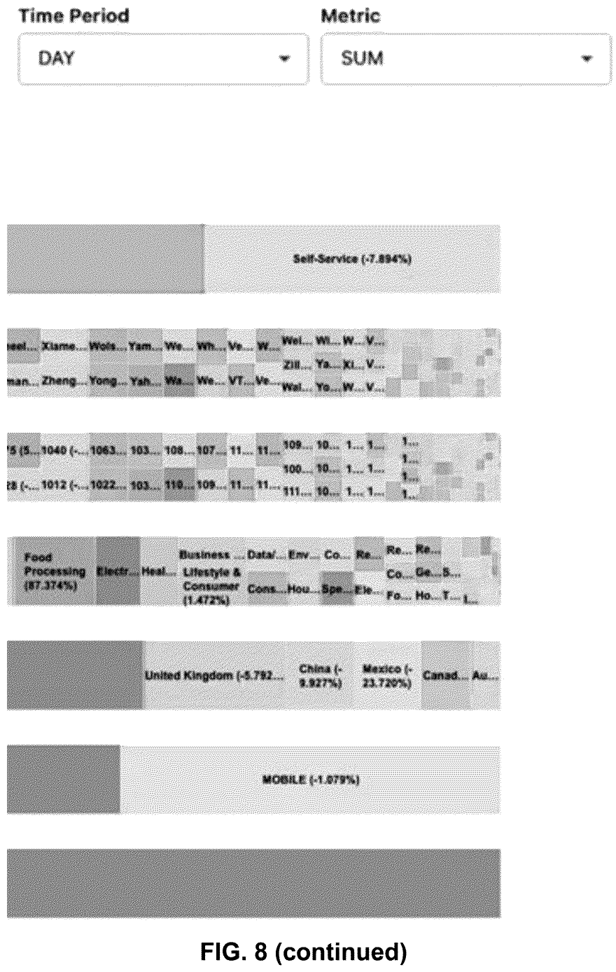

FIGS. 7A, 7B, 8, and-9 are diagrams illustrating example implementations of the analytics engine 218. As shown in FIG. 7A, the analytics engine 218 retrieves relevant portions of the cubed consumption dataset 502 and generates one or more analytics results 702, 704, 706, 712, 714, 716 and 722 based on the remaining dimensions. Even if consolidation is not implemented following dimension reduction, the analytics engine 218 may still generate analytics results from the cubed consumption dataset 502. In some embodiments, the analytics results may include metrics. In some embodiments, the generating of the one or more analytics results 702, 704, 706, 712, 714, 716 and 722 may be in response to a query. In the analytics results 702, 704, 706, 712, 714, 716 and 722, the analytics engine 218 aggregates quantities consumed across different groups of consumption records. Each different group of consumption records satisfy a given criteria or belongs to a given category. The given criteria may be based on common values of one or more of the consumption event attributes, including of the remaining eligible consumption event attributes following dimension removal. For example, in the analytics results 702, the analytics engine 218 aggregates quantities consumed across consumption records having a same consumption channel value. In the analytics results 704, the analytics engine 218 aggregates quantities consumed across any consumption records having a same tenant identifier. In the analytics results 706, the analytics engine 218 aggregates quantities consumed across any consumption records having a same tenant name. In the analytics results 712, the analytics engine 218 aggregates quantities consumed across any consumption records having a same country. In the analytics results 714, the analytics engine 218 aggregates quantities consumed across any consumption records having a same method. In the analytics results 716, the analytics engine 218 aggregates quantities consumed across any consumption records having a same sector.

In some embodiments, instead of aggregating quantities for a single consumption channel attribute, the analytics engine 218 may aggregate quantities, or perform other analyses, for a combination of consumption channel attributes. For example, in the analytics results 722, the analytics engine 218 may aggregate quantities across any consumption records having a combination of a same tenant name and a same consumption channel. Other analyses may be performed, such as obtaining a proportion of quantities consumed for consumption records satisfying a given criteria or a combination of criteria.

In some embodiments, the analytics engine 218 may pre-generate the one or more analytics results 702, 704, 706, 712, 714, 716 and 722, to speed up the turnaround time for responding to a query. Additionally, the one or more analytics results 702, 704, 706, 712, 714, 716 and 722 may be used as a starting point to evaluate and generate more complex analytics results, and/or generate visualizations such as a dashboard or a report related to the one or more analytics results 702, 704, 706, 712, 714, 716 and 722.

In some embodiments, instead of aggregating quantities, the analytics engine may generate other analytics results, such as a mean, median, mode, maximum, minimum, count, or standard deviation of the quantities across particular groups of consumption records.

In FIG. 7B, the analytics engine 218 retrieves relevant portions of the consolidated consumption dataset 592 and generates one or more analytics results 752, 754, 756, 758, 760, 762, and 764. In some embodiments, the generating of the one or more analytics results 752, 754, 756, 758, 760, 762, and 764 may be in response to a query. FIG. 7B illustrates that the consolidated consumption dataset 592 serves as a convenient starting point for quickly generating analytics results, and thus, consolidation further expedites the analytics process. In the example of FIG. 7B, similar to FIG. 7A, the analytics results 752, 754, 756, 758, 760, 762, and 764 indicate aggregate quantities consumed across different groups of consumption records. For example, the analytics results 752 indicate aggregate quantities consumed across a group of consumption records having a same tenant identifier. To determine the aggregate quantity consumed across all consumption records in which the tenant identifier is T-0001, the analytics engine 218 simply combines the quantities corresponding to the first and second bundles. To determine the aggregate quantity consumed across all consumption records in which the tenant identifier is U-0001, the analytics engine 218 simply obtains the quantity corresponding to the third bundle. To determine the aggregate quantity consumed across all consumption records in which the tenant identifier is V-0001, the analytics engine 218 simply obtains the quantity corresponding to the row 589. The analytics engine 218 may obtain analytics results simply by combining quantities across different bundles, obtaining quantities within a given bundle, or using other operations that are expedited as a result of the consolidated consumption dataset 592.

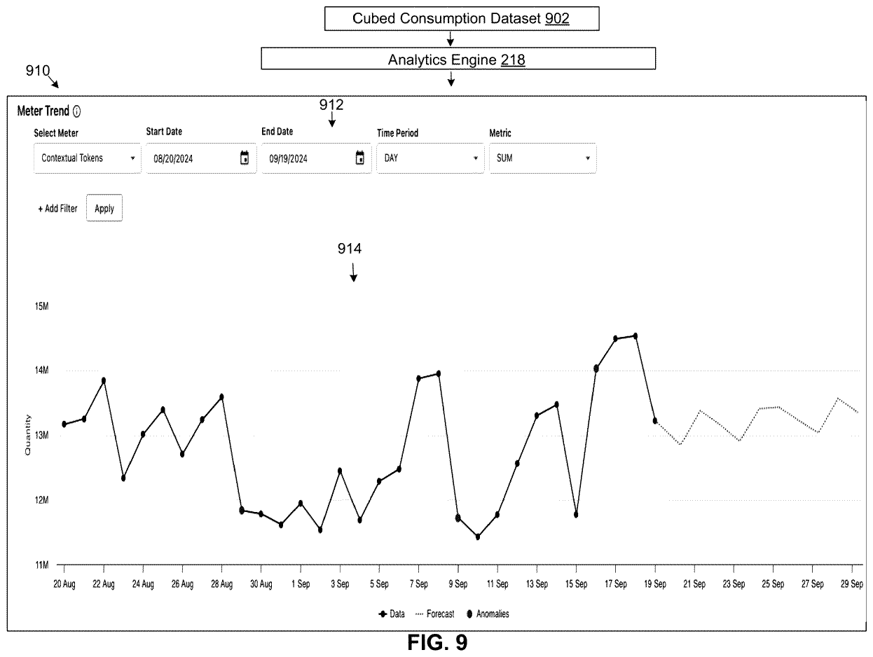

In FIGS. 8-9, the analytics engine 218 outputs graphical representations of its results. As shown in FIG. 8, the analytics engine 218 obtains relevant portions of a cubed consumption dataset 802, which may be implemented using similar principles as the cubed consumption dataset 502. In FIG. 8, the analytics engine 218 generates a graphical representation 810 containing a tab region 812 and an analytics region 814. The tab region 812 includes selectable dropdown tabs corresponding to different filter criteria for analysis. In some embodiments, under the “Select Meter” tab, different subscription resources are selectable. Within the tab region 812, different date ranges, time scales, analyses modes and operations are selectable. Analyses modes include root cause analysis and drill down analysis. Operations include count, sum, median, mode, proportion, minimum, and maximum. The analytics region 814 illustrates a breakdown of individual consumption event attributes, indicating a proportion of consumed resources satisfying a given criteria (e.g., consumption event attribute field) within corresponding consumption records.

FIG. 8 illustrates a summarized view of the cubed consumption dataset 802, which is presented in a user-friendly manner, and may be viewable on any computing device, including devices with smaller screens (e.g., mobile phones). Presentation of the summarized view is made feasible as a result of consolidating an underlying consumption dataset, in order to retain consumption event attributes that are likely to have a highest value for analysis purposes. Upon detecting a cursor hovering over, or selecting, one or more portions of the analysis region 814, the analytics engine 218 may output additional analysis including a quantity of consumed resources. In some embodiments, upon detecting a selection of one or more portions of the analysis region 814, the analytics engine 218 may launch one or more additional modules or applications that show more detailed analysis.

In FIG. 9, the analytics engine 218 obtains relevant portions of a cubed consumption dataset 902, which may be implemented using similar principles as the cubed consumption dataset 502 with different underlying cubed consumption data. In FIG. 9, the analytics engine 218 generates a graphical representation 910 containing a tab region 912 and an analytics region 914. The tab region 912 may be implemented in a similar manner as the tab region 812. The analytics region 914 includes a trend analysis of consumption resources consumed over a time period as well as predicted future consumption resources and indications of any anomalies.

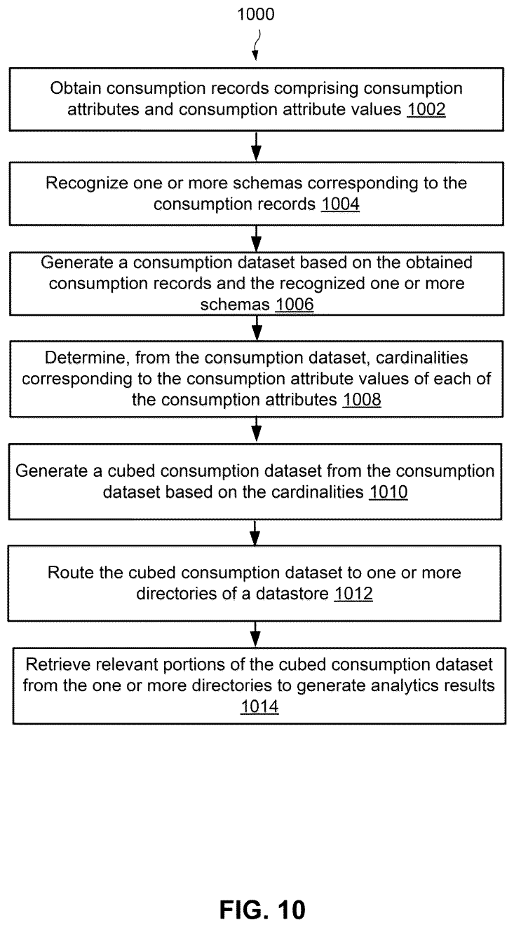

FIG. 10 is a flowchart of a method of intelligently cubing multi-dimensional consumption records, in accordance with some embodiments of the present invention. In step 1002, the records obtaining engine 209 may obtain the consumption records 208. The consumption records may include the consumption records 302, 304, 306, and 308 as illustrated in FIGS. 3A and 3B. The consumption records 208 may contain consumption event attributes 311, 313, 315, 317, 319, 321, 323, 325, and 327 and values 312, 314, 316, 318, 320, 322, 324, 326, and 328 corresponding to different consumption event attributes. In step 1004, the schema recognizing engine 210 may recognize a schema across the consumption records 208, as illustrated in FIGS. 3A and 3B. The schema recognizing engine 210 may recognize a format of the consumption records 208 and the consumption event attributes specified within the consumption records. In step 1006, the dataset generating engine 212 may generate a consumption dataset (e.g., the consumption dataset 402) that compiles the consumption records 208, as illustrated in FIG. 4. The generated consumption dataset may have a tabular format with a tabular schema consistent with the recognized schema.

In step 1008, the intelligent cubing engine 214 may determine, from the generated consumption dataset 402, cardinalities corresponding to eligible consumption event attributes. The eligible consumption event attributes may exclude certain metered consumption event attributes such as a quantity of consumption and temporal attributes. In step 1010, the intelligent cubing engine 214 may generate a cubed consumption dataset (e.g., the cubed consumption dataset 502) from the consumption dataset 402, based on the determined cardinalities. As illustrated in FIGS. 5A and 5B, columns corresponding to cardinalities that exceed an upper cardinality threshold are removed from the consumption dataset 402 and thus excluded from analytics, which constitutes a dimension reduction. In FIGS. 5A and 5B, these columns include the consumption subscription identifier column. In some embodiments, the intelligent cubing engine 214 may consolidate the dimensionally reduced consumption dataset, if matching rows occur, as illustrated in FIG. 5C. In step 1012, the routing engine 216 may route the cubed consumption dataset 502 to directories of a datastore, as illustrated in FIG. 6. In step 1014, the analytics engine 218 may retrieve the cubed consumption dataset 502 for analytics purposes. The analytics engine 218 may output one or more analytics results as illustrated in FIGS. 7A and 7B and/or graphical representations as illustrated in FIGS. 8-9.

In some embodiments, the steps illustrated in FIG. 10 may be performed at a given frequency, such as hourly, twice per hour, every two hours, daily, or any other frequency. In some embodiments, the intelligent cubing engine 214 may evaluate which consumption event attributes to be removed based on a window of time (e.g., within a previous hour) or a rolling period of time having a longer duration (e.g., within the last 24 hours, within the last week, or within the last month). That is, the intelligent cubing engine 214 may evaluate which consumption event attributes to be removed based on consumption records within the rolling period of time. The rolling period of time may exceed a duration of time between successive evaluations by the intelligent cubing engine 214. For example, assume that the rolling period of time is one day and that the intelligent cubing engine 214 evaluates every hour. On Oct. 15, 2024 at 1:00 PM, the intelligent cubing engine 214 evaluates based on consumption records from Oct. 14, 2024 at 1:00 PM to Oct. 15, 2024 at 1:00 PM. On Oct. 15, 2024 at 2:00 PM, the intelligent cubing engine 214 evaluates based on consumption records from Oct. 14, 2024 at 2:00 PM to Oct. 15, 2024 at 2:00 PM. In this manner, the intelligent cubing engine 214 dynamically adjusts which consumption event attributes to be retained, depending on the most useful consumption event attributes at a given time.

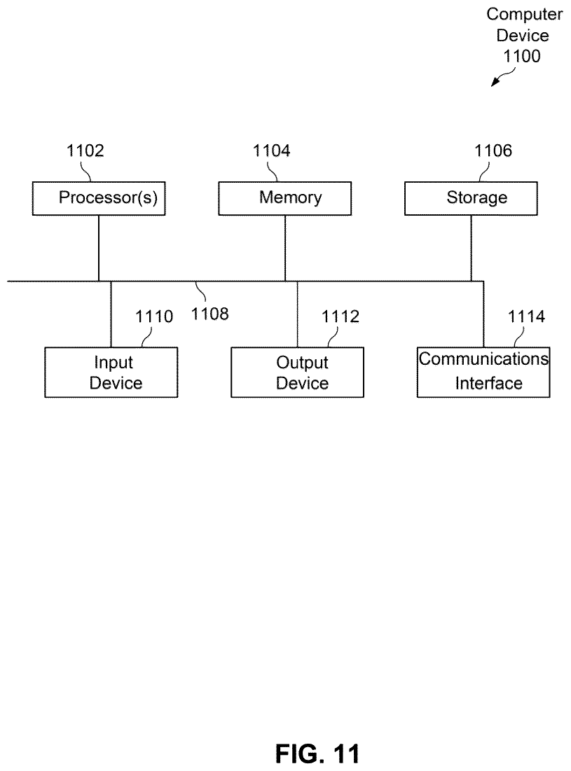

FIG. 11 is a block diagram of a computing device 1100. Any of the systems, engines, datastores, and/or networks described herein may comprise an instance of one or more computing devices 1100. In some embodiments, functionality of the computing device 1100 is improved to perform some or all of the functionality described herein. The computing device 1100 comprises a processor 1112, memory 1114, storage 1116, an input device 1120, a communication network interface 1124, and an output device 1122 communicatively coupled to a communication channel 1118. The processor 1112 is configured to execute executable instructions (e.g., programs). In some embodiments, the processor 1112 comprises circuitry or any processor capable of processing the executable instructions.

The memory 1114 stores data. Some examples of memory 1114 include storage devices, such as RAM, ROM, RAM cache, virtual memory, etc. In various embodiments, working data is stored within the memory 1114. The data within the memory 1114 may be cleared or ultimately transferred to the storage 1116.

The storage 1116 includes any storage configured to retrieve and store data. Some examples of the storage 1116 include flash drives, hard drives, optical drives, cloud storage, and/or magnetic tape. In some embodiments, storage 1116 may include RAM. Each of the memory 1114 and the storage 1116 comprises a computer-readable medium, which stores instructions or programs executable by processor 1112.

The input device 1120 may be any device that inputs data (e.g., mouse and keyboard). The output device 1122 may be any device that outputs data and/or processed data (e.g., a speaker or display). It will be appreciated that the storage 1116, input device 1120, and output device 1122 may be optional. For example, the routers/switchers may comprise the processor 1112 and memory 1114 as well as a device to receive and output data (e.g., the communication network interface 1124 and/or the output device 1122).

The communication network interface 1124 may be coupled to a network (e.g., the network system 100) via the link 1118. The communication network interface 1124 may support communication over an Ethernet connection, a serial connection, a parallel connection, and/or an ATA connection. The communication network interface 1124 may also support wireless communication (e.g., 802.11 a/b/g/n, WiMax, LTE, WiFi). It will be apparent that the communication network interface 1124 may support many wired and wireless standards.

It will be appreciated that the hardware elements of the computing device 1100 are not limited to those depicted. A computing device 1100 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1112 and/or a co-processor located on a GPU (i.e., NVidia).

It will be appreciated that an “engine,” “system,” “datastore,” and/or “database” may comprise software, hardware, firmware, service, microservice, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance. It will be appreciated that the term “request” shall include any computer request or instruction, whether permissive or mandatory.

The databases/datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise. References to objects may refer to data representations that include fields and/or attributes that define the data.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A multi-tenant system, comprising:
one or more hardware processors; and
memory storing computer instructions, the computer instructions when executed by the one or more hardware processors configured to perform:
obtaining consumption records, the consumption records comprising consumption event attributes and consumption event attribute values;
recognizing one or more schemas corresponding to the obtained consumption records;
generating a consumption dataset to compile the obtained consumption records based on the recognized one or more schemas;
determining, from the generated consumption dataset, cardinalities of each of eligible consumption event attributes, each cardinality indicative of a number of unique consumption event attribute values of each of the eligible consumption event attributes;
generating a cubed consumption dataset from the consumption dataset based on the determined cardinalities;
routing the cubed consumption dataset to one or more directories of a datastore;
evaluating analytics results from the cubed consumption dataset; and
outputting the analytics results.

2. The multi-tenant system of claim 1, wherein the generating of the consumption dataset comprises generating the consumption dataset in a tabular format having a tabular schema consistent with the recognized one or more schemas.

3. The multi-tenant system of claim 1, wherein at least a portion of the obtained consumption records have different schemas, and the recognizing of the one or more schemas comprises combining the different schemas.

4. The multi-tenant system of claim 1, wherein the recognizing of the one or more schemas comprises recognizing a changed schema, the changed schema comprising an additional consumption event attribute or a removal of a previous consumption event attribute, and the generating of the consumption dataset is based on the recognized changed schema.

5. The multi-tenant system of claim 1, wherein the generating of the consumption dataset comprises populating the consumption event attributes from the consumption records; and the generating of the cubed consumption dataset from the consumption dataset comprises:
selecting one or more to-be-removed consumption event attributes, from the eligible consumption event attributes, for removal from the consumption dataset; and
removing the one or more to-be-removed consumption event attributes from the consumption dataset.

6. The multi-tenant system of claim 5, wherein the selecting of the one or more to-be-removed consumption event attributes comprises selecting for removal any of the eligible consumption event attributes having a cardinality that exceeds a cardinality threshold.

7. The multi-tenant system of claim 5, wherein the selecting of the one or more to-be-removed consumption event attributes comprises retaining a given number of the eligible consumption event attributes having lowest cardinalities.

8. The multi-tenant system of claim 5, wherein the selecting of the one or more to-be-removed consumption event attributes comprises retaining a given number of the eligible consumption event attributes having lowest cardinalities above a minimum cardinality threshold.

9. The multi-tenant system of claim 5, wherein the generating of the cubed consumption dataset comprises:
after removing the one or more to-be-removed consumption event attributes, consolidating matching events corresponding to consumption events having common consumption event attribute values for the remaining eligible consumption event attributes into a bundle, and generating metrics associated with the bundle.

10. The multi-tenant system of claim 5, wherein the eligible consumption event attributes exclude temporal attributes indicative of a time or day of consumption and quantity attributes indicative of a quantity of consumption.

11. A method implemented by a multi-tenant system, the method comprising:
obtaining consumption records, the consumption records comprising consumption event attributes and consumption event attribute values;
recognizing one or more schemas corresponding to the obtained consumption records;
generating a consumption dataset to compile the obtained consumption records based on the recognized one or more schemas;
determining, from the generated consumption dataset, cardinalities of each of eligible consumption event attributes, each cardinality indicative of a number of unique consumption event attribute values of each of the eligible consumption event attributes;
generating a cubed consumption dataset from the consumption dataset based on the determined cardinalities;
routing the cubed consumption dataset to one or more directories of a datastore;
evaluating analytics results from the cubed consumption dataset; and
outputting the analytics results.

12. The method of claim 11, wherein the generating of the consumption dataset comprises generating the consumption dataset in a tabular format having a tabular schema consistent with the recognized one or more schemas.

13. The method of claim 11, wherein at least a portion of the obtained consumption records have different schemas, and the recognizing of the one or more schemas comprises combining the different schemas.

14. The method of claim 11, wherein the recognizing of the one or more schemas comprises recognizing a changed schema, the changed schema comprising an additional consumption event attribute or a removal of a previous consumption event attribute, and the generating of the consumption dataset is based on the recognized changed schema.

15. The method of claim 11, wherein the generating of the consumption dataset comprises populating the consumption event attributes from the consumption records; and the generating of the cubed consumption dataset from the consumption dataset comprises:
selecting one or more to-be-removed consumption event attributes, from the eligible consumption event attributes, for removal from the consumption dataset; and
removing the one or more to-be-removed consumption event attributes from the consumption dataset.

16. The method of claim 15, wherein the selecting of the one or more to-be-removed consumption event attributes comprises selecting for removal any of the eligible consumption event attributes having a cardinality that exceeds a cardinality threshold.

17. The method of claim 15, wherein the selecting of the one or more to-be-removed consumption event attributes comprises selecting for removal a given number of the eligible consumption event attributes having highest cardinalities.

17. The method of claim 15, wherein the selecting of the one or more to-be-removed consumption event attributes comprises retaining a given number of the eligible consumption event attributes having lowest cardinalities above a minimum cardinality threshold.

19. The method of claim 15, wherein the generating of the cubed consumption dataset comprises:
after removing the one or more to-be-removed consumption event attributes, consolidating matching events corresponding to consumption events having common consumption event attribute values for the remaining eligible consumption event attributes into a bundle, and generating metrics associated with the bundle.

20. The method of claim 15, wherein the eligible consumption event attributes exclude temporal attributes indicative of a time or day of consumption and quantity attributes indicative of a quantity of consumption.
